(19) United States
(12) Patent Application Publication
(10) Pub. No.: US 2018/0328867 A1
(43) Pub. Date: Nov. 15, 2018

(54) IMPROVED METHOD PTYCHOGRAPHIC DETECTOR MAPPING

(71) Applicant: PHASE FOCUS LIMITED, Sheffield (GB)

(72) Inventor: Martin James Humphry, Nottingham (GB)

(21) Appl. No.: 15/776,626

(22) PCT Filed: Nov. 21, 2016
(86) PCT No.: PCT/GB2016/053621

§ 371 Date: May 16, 2018

(30) Foreign Application Priority Data
Nov. 19, 2015 (GB) 1520426.6

(51) Int. Cl. G01N 23/20; G01T 1/29

(52) U.S. Cl. CPC G01N 23/20; G01N 2223/402; G01T 1/29

(57) ABSTRACT

Embodiments of the present invention provide a computationally implemented method comprising determining an array of elements at which a wavefront is to be estimated, determining a mapping between one or more of a plurality of detector elements of a detector at which incident radiation is to be measured and one or more of the array elements, and iteratively estimating the wavefront at the one or more of the plurality of detector elements, wherein said iteratively estimating comprises determining an estimated wavefront at the array of elements, and determining an estimated intensity of radiation at the detector based on an intensity of radiation measured at the detector scattered from a target object and the mapping between the array of elements and the one or more of the plurality of detector elements.

### BACKGROUND

The present invention relates to methods and apparatus for determining one or both of information about a target object or attributes of incident radiation.

WO 2005/106531, which is incorporated herein by reference for all purposes, discloses a method and apparatus of providing image data for constructing an image of a region of a target object. Incident radiation is provided from a radiation source at the target object. An intensity of radiation scattered by the target object is detected using at least one detector. The image data is provided responsive to the detected radiation. A method for providing such image data via an iterative process using a moveable probe function is disclosed. The methods and techniques disclosed in WO 2005/106531 are referred to as a ptychographical iterative engine (PIE).

PIE provides for the recovery of image data relating to at least an area of a target object from a set of diffraction pattern measurements or to the determination of information associated with radiation illuminating the target object. Several diffraction patterns are recorded at a measurement plane using one or more detectors, such as a CCD or the like.

WO 2010/064051, which is incorporated herein by reference for all purposes, discloses an enhanced PIE (ePIE) method wherein it is not necessary to know or estimate a probe function. Instead a process is disclosed in which the probe function is iteratively calculated step by step with a running estimate of the probe function being utilised to determine running estimates of an object function associated with a target object.

Other methods are known which are referred to a coherent diffraction imaging (CDI) which are based on the measurement of scattered radiation, such as that by P Thibault, Dierolf, et al entitled “Probe Retrieval in Ptychographic Coherent Diffractive Imaging” disclosed in Ultramicroscopy, 109, 1256-1262 (2009) and WO2011033287 entitled “Method And Apparatus For Retrieving A Phase Of A Wavefield”, which is herein incorporated by reference, by the present inventor.

Ptychography, up until now, has relied on diffraction patterns measured using a regular 2D matrix of detector pixels. Whilst this is computationally convenient it is not always the most appropriate experimental configuration. It is the aim of embodiments of the invention to enable arbitrary detector geometries to be used in ptychography.

In ptychography object and illumination functions (plus, in some embodiments, other experimental parameters such as illumination positions) are iteratively refined until a set of forward propagated wavefronts (Ψₕ(u)) are consistent with radiation measured at a detector. In particular, whether an intensity of propagated wavefronts (Ψⱼ(u)) are consistent with the intensity of radiation measured at the detector. For mathematical convenience the object and illumination functions are generally represented as 2D (or 3D) regular arrays. However experimental configurations and detector geometries may not perfectly match these regular arrays.

It is an object of embodiments of the invention to at least mitigate one or more of the problems of the prior art.

### SUMMARY OF THE INVENTION

According to a first aspect of the present invention there is provided methods and apparatus as set forth in the appended claims.

According to an embodiment of the invention there is provided a method comprising determining an array of elements at which a wavefront is to be estimated, determining a mapping between one or more of a plurality of detector elements at which incident radiation is to be measured and one or more of the array elements.

In some embodiments, each detector element is associated with a plurality of array elements. In other embodiments, each array element is associated with a plurality of detector elements.

The mapping may be indicative of a portion of the array elements associated with the one or more detector elements. The mapping may comprise identification information for each detector element associated with each array element. Some array elements may not be associated with corresponding detector elements.

The mapping may comprise, for each array element, a weighting value. The weighting value may be indicative of a relative contribution of each array element to the detector element. The weighting value may be between first and second predetermined values. The second predetermined value, such as 1, may indicate a full contribution, whilst the first predetermined value may indicate less contribution, such as no contribution.

The wavefront may be estimated by a ptychographic method. The wavefront may be estimated by an iterative phase retrieval method. The wavefront estimated may be updated. The wavefront may be estimated based on a probe function indicative of one or more characteristics of radiation incident on an object or a post-object aperture, and an object function indicative of one or more characteristics of the object. The wavefront may be estimated by a direct calculation method

### BRIEF DESCRIPTION OF THE DRAWINGS

Embodiments of the invention will now be described by way of example only, with reference to the accompanying figures, in which:

FIG. 1 shows an apparatus according to an embodiment of the invention;

FIG. 2 illustrates a location of data structures according to an embodiment of the invention;

FIG. 3 illustrates detector elements according to an embodiment of the invention;

FIG. 4 shows a quadranted detector overlaid onto a regular 2D array according to an embodiment of the invention;

FIG. 5 shows stacked/misaligned detectors, four pixelated detector arrays stacked or arrayed together with alignment errors and gaps there-between according to an embodiment of the invention;

FIG. 6 shows tilt/distortion of a measured detector array according to an embodiment of the invention;

FIG. 7 illustrates a method according to an embodiment of the invention; and

FIG. 8 illustrates an apparatus according to an embodiment of the invention.

### DETAILED DESCRIPTION OF EMBODIMENTS OF THE INVENTION

FIG. 1 illustrates an apparatus 100 according to an embodiment of the invention. The apparatus is suitable to provide image data of an object which may, although not exclusively, be used to produce an image of at least a region of the object. The apparatus 100 may also be used to determine one or more attributes of radiation illuminating the object. The apparatus 100 may also be used to determine the relative displacement between the incident radiation and the object.

A radiation source, which although not shown in FIG. 1, is a source of radiation 10 which falls upon a focusing arrangement 20, such as one or more lenses, and is caused to illuminate a region of a target object 30. It is to be understood that the term radiation is to be broadly construed. The term radiation includes various wave fields. Radiation includes energy from a radiation source. This will include electromagnetic radiation including X-rays, emitted particles such as electrons. Other types of radiation include acoustic radiation, such as sound waves. Such radiation may be represented by a wave function ψ(r). This wave function includes a real part and an imaginary part as will be understood by those skilled in the art. This may be represented by the wave functions modulus and phase.

The lens 20 forms a probe function P(r) which is arranged to select a region of the target object 30 for investigation. The probe function selects part of an object exit wave for analysis. P(r) is the complex stationary value of this wave field calculated at the plane of the object 30.

It will be understood that rather than weakly (or indeed strongly) focusing illumination on the target object 30, unfocused radiation can be used with a post target aperture. An aperture is located post target object to thereby select a region of the target for investigation. The aperture is formed in a mask so that the aperture defines a “support”. A support is an area of a function where that function is not zero. In other words outside the support the function is zero. Outside the support the mask blocks the transmittance of radiation. The term aperture describes a localised transmission function of radiation. This may be represented by a complex variable in two dimensions having a modulus value between 0 and 1. An example is a mask having a physical aperture region of varying transmittance.

Incident radiation thus falls upon the up-stream side of the target object 30 and is scattered by the target object 30 as it is transmitted. The target object 30 should be at least partially transparent to incident radiation. The target object 30 may or may not have some repetitive structure. Alternatively the target object 30 may be wholly or partially reflective in which case a scattering pattern is measured based on reflected radiation.

An exit wave ψ(r) is formed after interaction of the illuminating radiation with the object 30. In this way ψ(r) represents a two-dimensional complex function so that each point in ψ(r), where r is a two-dimensional coordinate, has associated with it a complex number. ψ(r) will physically represent a wave that would emanate from the object 30. The object 30 can be represented by a complex function, O(r), with its complex value given by a modulus and phase which represent the modulus and phase alterations introduced by the object 30 into a perfect plane wave incident upon it. For a thin object (one in which the interaction between object 30 and probe can be approximated to occur in a single plane), the exit wave will be given by: ψ(r)=O(r)·P(r), however it will be understood that a more complex model can be used to generate the exit wave, such as a multi-slice calculation disclosed by the present applicant in WO2012038749. The probe function P(r) selects a part of the object exit wave function for analysis. It will be understood that rather than selecting an aperture, a transmission grating or other such filtering function may be located downstream of the object. The probe function P(r) may be an aperture transmission function. The probe function can be represented as a complex function with its complex value given by a modulus and phase which represent a complex stationary value of this wave field calculated at the plane of the object.

This exit wave ψ(r) may form a diffraction pattern Ψ(u) at a diffraction plane. Here u is a two-dimensional coordinate in a detector plane. The diffraction pattern Ψ(u) may be the Fourier transform of the exit wave ψ(r).

It will be understood that if the diffraction plane at which scattered radiation is detected is moved nearer to the specimen then Fresnel diffraction patterns will be detected rather than Fourier diffraction patterns. In such a case the propagation function from the exit wave ψ(r)) to the diffraction pattern Ψ(u) will be a Fresnel transform rather than a Fourier transform. It will also be understood that the propagation function from the exit wave ψ(r) to the diffraction pattern Ψ(u) may be modelled using other transforms.

In order to select the region of the target object 30 to be illuminated or probed, the lens(es) 20 or aperture may be mounted upon an x/y translation stage which enables movement of the probe function with respect to the object 30. Equally, it will also be realised that the object 30 may be moved with respect to the lens(es) 20 or aperture. The relative translation can be implemented by moving a translation stage in a grid arrangement of positions or a spiral arrangement among any others. It is also possible to rely on drift of probe or object to provide the translation diversities i.e. without using a translation stage or other means to cause movement of, for example, the object.

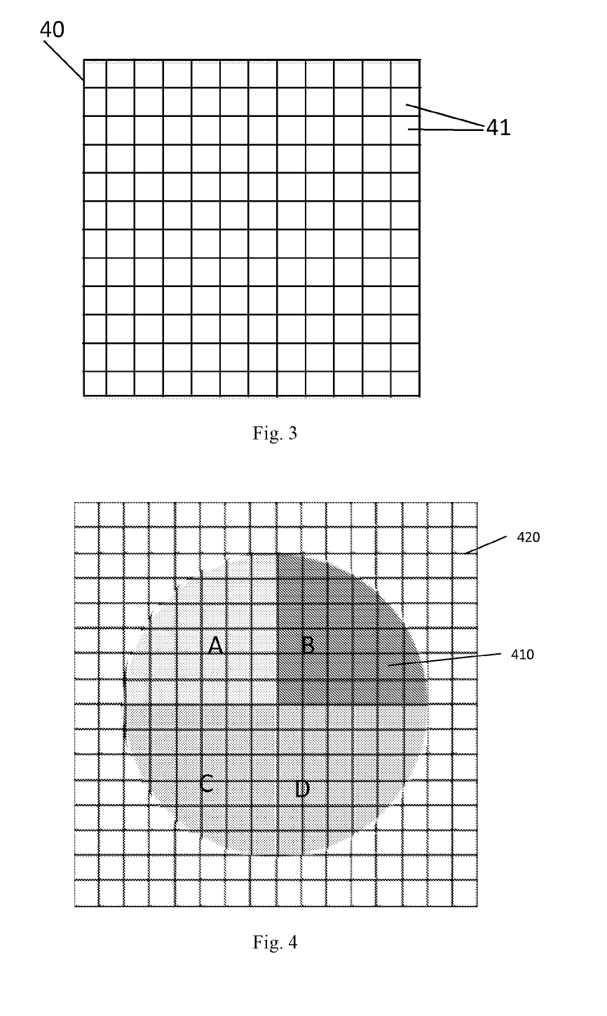

A detector 40 is a suitable recording device such as a CCD camera or the like which allows the diffraction pattern to be recorded. The detector 40 allows the detection of the diffraction pattern in a detector plane i.e. a plane different from that of the object 30. The detector 40 comprises an array of detector elements, such as in a CCD, as will be discussed in relation to FIG. 3 in particular.

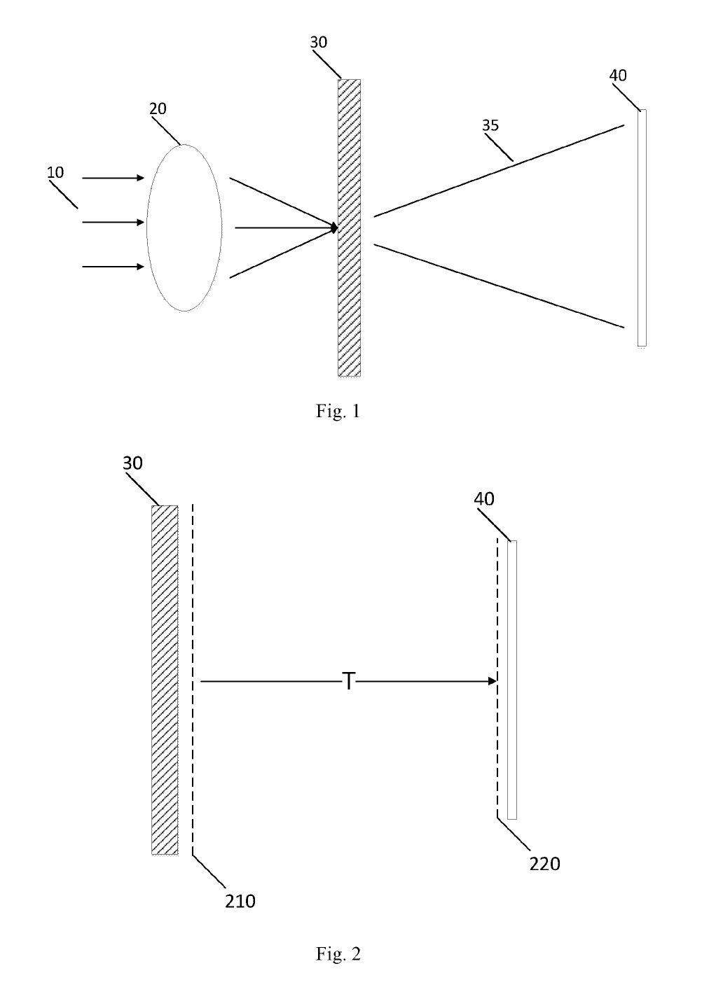

Referring to FIG. 2, as noted above, the exit wave ψ(r) from the object is represented as a two-dimensional complex function so that each point in ψ(r), where r is a two-dimensional coordinate, has associated with it a complex number. A data structure such as an array is used to store the exit wave ψ(r). FIG. 2 illustrates a location 210 of the exit wave ψ(r) in relation to the object 30. The exit wave ψ(r) is determined at a plane 210 which may be a plane aligned with a downstream surface of the object 30, although as illustrated in FIG. 2 a separation between the object 30 and the plane 210 is shown for clarity. The propagation function T from the exit wave ψ(r)) to the diffraction pattern Ψ(u) is applied to determine the diffraction pattern Ψ(u) at a plane 220 of the detector 40, although a small separation is shown in FIG. 2 between the plane 220 and the detector 40 for clarity. As with the exit wave a data structure, such as an array, is used to store the diffraction pattern Ψ(u). The data structure storing the representation of the diffraction pattern Ψ(u) will be referred to as a diffraction pattern array 220.

FIG. 3 illustrates the detector 40 as viewed face-on i.e. in cross-section. The detector comprises a plurality of detector elements 41, only two of which are indicated with reference numerals for clarity. Often the detector elements 41 are arranged in a grid arrangement, as shown in FIG. 3, with detector elements 41 being arranged in columns and rows with each detector element 41 being substantially consecutive to the next detector element 41 vertically and horizontally. The diffraction pattern array 220 is configured in prior art embodiments to have array elements corresponding to the detector elements. That is, in prior art embodiments, one array element is used to store an estimate of the intensity of radiation measured by a corresponding detector element 41. However embodiments of the invention facilitate an irregular correspondence between array elements and detector elements, as will be explained.

The present inventors have determined that it is possible to map from a 2D regular array to the actual physical detector shape(s).

In the illustration of FIG. 4, a simple, commonly used, quadranted detector 410 is overlaid onto a regular 2D array 420. Each of the four segments (A-D) of the detector 410 represents a single real detector element, which covers a number of elements (pixels) in the 2D array 420, some only partially. The signal recorded by each quadrant of the detector 410 will be proportional to the incoherent sum of all the pixel elements it covers in the 2D array 420. Note that some pixels 420 have fractional or partial coverage, which are also accounted for in the disclosed mapping method.

It should be apparent that other numbers of segments may be envisioned, as could different physical arrangements such as quadranted concentric rings. Such detectors are often used in electron and optical microscopy.

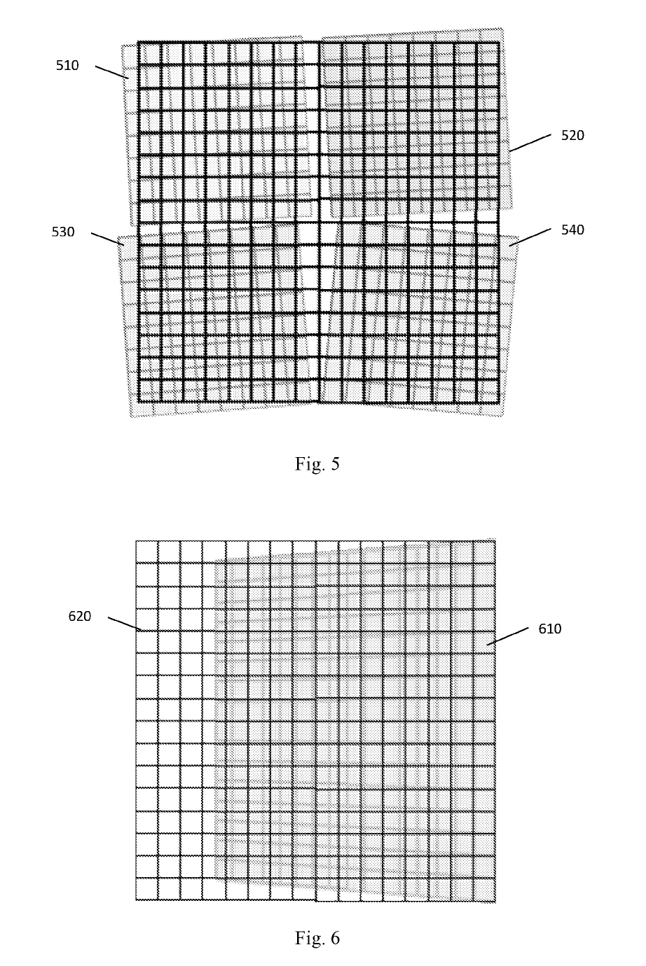

A second illustration, as shown in FIG. 5, shows four pixelated detectors 510, 520, 530, 540, each comprising an array of detector elements, which are stacked or arrayed together with (unintentional) alignment errors and gaps between the respective detectors 510, 520, 530, 540. Each detector 510, 520, 530, 540 comprises a regular array of square detector elements. Each large coloured square represents a detector 510, 520, 530, 540 array with a regular 2D array, at which a wavefront is estimated, overlaid on top of the detectors 510, 520, 530, 540. Such a situation is common in X-ray ptychography where each diffraction pattern is measured using a set of smaller detector sub-arrays physically stacked together.

A third example is the general situation of a geometric distortion of a measured detector array 610, as shown in FIG. 6. This could be due to the geometry of the detector 610 relative to the object (e.g. a tilt), a distortion due to an optical projection system (e.g. within a transmission electron microscope) or any other source of geometric distortion.

Methods according to embodiments of the present invention also enable the accommodation of binned detectors, where the pixel size is larger than that used in the reconstruction algorithm i.e. at which a diffraction pattern is estimated, and sparse detectors where the pixel fill-factor is less than one, which may be significantly less than one.

To resolve the differences between the forward-calculated 2D array and the physical detector geometry, a detector mapping approach has been developed. Each detector element e is mapped to one or more pixel element(s) in a forward-calculated diffraction pattern wavefront array (Ψ(u)). A weighting coefficient between first and second values, such as 0 and 1, may be associated with each pixel element to account for partial overlap, as illustrated in FIG. 4 and discussed above as example 1.

Continuing with example 1, if the four quadrants are labelled A, B, C and D, the first few entries in the map for quadrant A may be:

### A: (6,3,0.5);(7,3,0.7);(8,3,1);(5,4,0.2);(6,4,0.7);(7,4,1);(8,4,1);(4,5,0.7);(5,5,1);(6,5,1)

. . .

A reference or origin location is determined for the mapping. In the above example, the origin is the top-left pixel of the wavefront array is identified as 1,1. Where the first two numbers in brackets represent the x,y co-ordinates of the pixel elements mapped to that detector and the, optional, third number is the weighting factor. It will be appreciated that other representations of the map are also possible.

In the ptychographic methods, such as that disclosed by WO2005106531, which is herein incorporated by reference, the forward-calculated wavefront is updated using the measured diffraction pattern intensity as follows:

$${Ψ}_{new} ( u ) = Ψ ( u ) \cdot \frac{\sqrt{I ( u )}}{\vert Ψ ( u ) \vert} \qquad Eqn 1$$

Where Ψ_{new} (ψ_{new} in the priority document) is the updated wavefront, Ψ is the forward-calculated wavefront (ψ_{fwd} in the priority document, where Ψ=ψ_{fwd}) and I(u) is the measured intensity at the detector plane. This is generally termed the “modulus projection”. All functions are 2D arrays, represented by the co-ordinate vector u.

Incoherent modes may be incorporated into a ptychographic reconstruction. In this case, the measured intensity is used to scale each pixel in each mode according to:

$${Ψ}_{new} ( u , m ) = {Ψ}_{fwd} ( u , m ) . \sqrt{\frac{I ( u )}{{Σ}_{m} \vert {Ψ}_{fwd} ( u , m ) {\vert}^{2}}} \qquad Eqn 2$$

Where m is the mode number. The denominator inside the square root is essentially the incoherent sum of all modes.

In the prior art, the calculations rely on regular grids. Embodiments of the present invention enable arbitrary detector geometries to be used. Instead of incoherent modes, Eqn 2 can be applied to a sum of pixels in the forward-calculated wavefront, Ψ_{fwd}, incident on a detector element. Thus, as explained above with reference to example 1, each element of the detector, such as quadrant A, may be associated with a plurality of elements of the forward calculated wavefront.

For each detector element, the corresponding pixels in Ψ_{fwd}, mapped to it via the detector map, can be updated via:

$${Ψ}_{new} ( u ) = {Ψ}_{fwd} ( u ) . \sqrt{\frac{{I}_{e}}{{Σ}_{px} ( {a}_{px} . \vert {Ψ}_{fwd} ( px ) {\vert}^{2} )}} \qquad Eqn 3$$

Where e is the detector element mapped to pixels, px, in the forward-calculated wavefront and aₚₓ is the weighting factor for that pixel. Eqn 3 can therefore be applied to each element in the detector in turn, resulting in an updated wavefront for use in the remainder of the iterative ptychography reconstruction.

It is important to note that some pixels in the forward-calculated wavefront may not be mapped to a detector element. These pixels will therefore not be modified by Eqn 3, allowing for gaps between detector elements to be accommodated. The pixels in the forward calculated wavefront not mapped to detector elements are allowed to “float” where the pixel value is not updated; instead the forward-calculated value is retained.

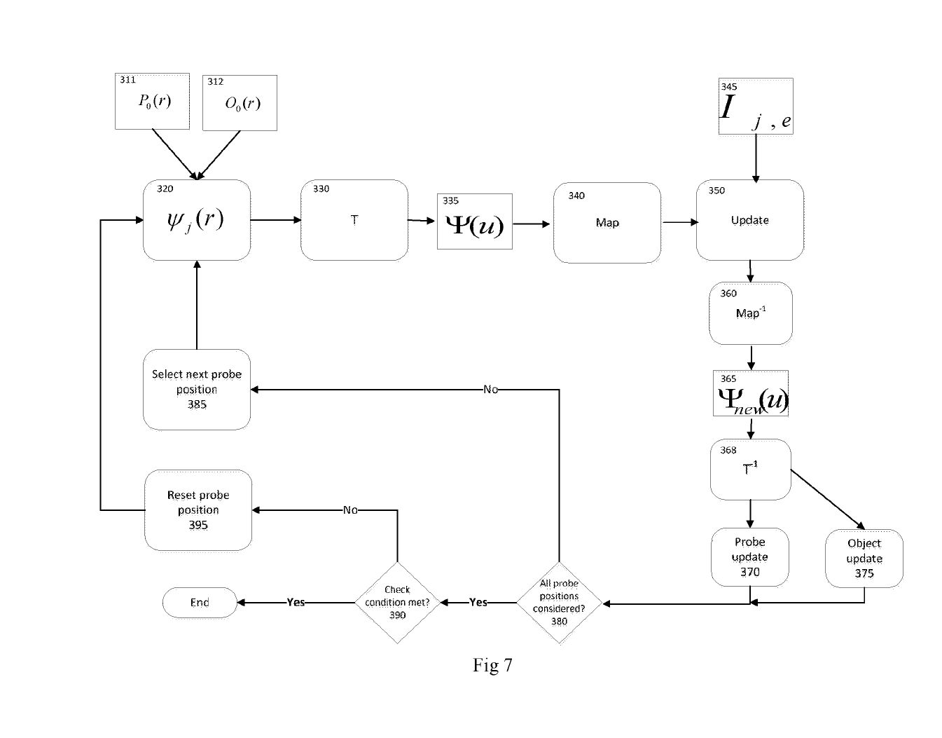

FIG. 7 illustrates a method according to an embodiment of the invention. The method illustrated in FIG. 7 involves simultaneous, step-by-step updating of both probe and object function estimates. However, it will also be realised that embodiments of the invention may be envisaged in which only the object function may be updated and a known probe function may be used, as in the methods and apparatus disclosed by WO 2005/106531, for example. Furthermore, in other embodiments of the invention, a known object function may be used and the method may determine the probe function. It will also be appreciated that the object function and/or probe function may be updated by other methods. Furthermore, embodiments of the invention may be envisaged in which a so-called ‘difference map’ algorithm is used in which all diffraction patterns are considered in parallel, as described in Probe retrieval in ptychographic coherent diffractive imaging, Pierre Thibault, Martin Dierolf, Oliver Bunk, Andreas Menzel, Franz Pfeiffer, Ultramicroscopy Volume 109, Issue 4, March 2009, Pages 338-343, which is incorporated herein by reference.

The method utilises a set of J diffracted intensities, Iⱼ (e), recorded by the detector 40, wherein each diffracted intensity Iⱼ consists of a set of e detector elements. The method attempts to minimise a difference between the measured intensity Iⱼ(e) of radiation and the forward calculated wavefront as mapped to the elements of the detector 40 as the measured intensity. This may be expressed as:

I_{fwd}=Σₚₓ₍ₑ₎(a(px(e))|Ψⱼ(px(e))|²) Eqn 4

wherein I_{fwd} is the incoherent sum of all pixels in the forward calculated wavefront, px(e) mapped to each detector element, e, consisting of the square of the modulus of the wavefront incident upon the detector 40.

Within each iteration of the method an estimate of the probe and object functions is updated for each of the J diffraction patterns measured by the detector 40. An order of considering each of the J measured intensities is chosen. The order may be numerically sequential i.e. j=1, 2, 3 . . . J. In this case, beginning with diffraction pattern j and progressing through to J updated estimates of the probe P₁(r) . . . P_{J}(r) and object O₁(r) . . . O_{J}(r) are produced. However, considering the diffraction patterns in a raster fashion (each pattern in a row sequentially and each row sequentially) may cause problems particularly in relation to the estimate of the probe function drifting during the method. Therefore, in some embodiments, the diffraction patterns may be considered in a random or other pseudo-random order. However, for the purposes of explanation, a sequential ordering of the set of diffraction patterns will be considered.

Prior to a first (k=1) iteration of the method, initial probe P₀ (r) 311 and object O₀(r) 312 functions are selected. The initial probe P₀ (r) and object O₀(r) functions 311, 312 may be predetermined initial values, such as initial guesses i.e. pre-calculated approximations, random distributions, or may be based on other initial measurements or prior calculations. The functions are modelled at a number of sample points and are thus represented by matrices. Such matrices can be stored and manipulated by a computer or other such processing unit. In some embodiments, the sample points are equally spaced and form a rectangular array.

In step 320 an exit wave ψⱼ(r) is determined by multiplying the current object and probe functions. For the first (k=1) iteration of the method, for the first probe position j=1, the initial probe P₀(r) and object functions O₀(r) are multiplied to determine the first exit wave ψ₁(r). For subsequent iterations of the method, the currently selected function i.e. Oⱼ(r) Pⱼ(r) are multiplied to determine the current exit wave ψⱼ(r).

In step 330 the exit wave ψⱼ(r) is propagated to a measurement plane of the detector 40. The propagation produces an estimate Ψⱼ(u) of the wavefront at the plane of the detector 40 as indicated by step 335. The exit wave ψⱼ(r) is propagated to the measurement plane by a suitable transform T, as shown in Equation 5. In some embodiments, the transform T may be a Fourier transform, although in other embodiments the transform may be a Fresnel free space propagator. It is also envisaged that other transforms may be used which are suited to the particular application of the method.

Ψⱼ(u)=T[ψⱼ(r)] Equation 5

In step 340 a mapping is performed between the array of elements at which the forward calculated wavefront (u) is estimated and the elements e of the detector 40 at which incident radiation is measured. Similarly, in step 360 a reverse of the mapping is performed between an updated wavefront at the detector 40 and the array of elements at which the wavefront Ψⱼ(u) was previously estimated. In some embodiments, steps 340, 360 (explained below) are integrated into a single step which includes the mapping in both directions (from and to the array of elements at which the forward calculated wavefront is estimated) and updating of the forward calculated wavefront based on the radiation measured by the detector 40.

In step 350 the forward calculated wavefront Ψⱼ(u) at the plane of the detector 40 is updated based on the measured diffraction pattern Iⱼₑ received in step 345 of FIG. 4. As explained in the cited references, since Ψⱼ(u) is a complex-value, it may be written as shown in Equation 6:

Ψⱼ(u)=Aⱼ(u)exp(iϕⱼ(u)) Equation 6

A modulus of the forward calculated wavefront Ψⱼ(u) may updated based on the measured intensity Iⱼₑ. Therefore, as explained above with reference to Equations 3 and 4, for each detector element e, the updated wavefront Ψ_{new} may be determined as:

$${Ψ}_{j , new} ( u ) = {Ψ}_{j} ( u ) . \sqrt{\frac{{I}_{j , e}}{{I}_{fwd}}} \qquad Equation 7$$

In step 368 the updated wavefront Ψ_{j,}_{_{new}}(u) is reverse propagated back to a plane of the object 30. The inverse propagation is performed according to the reverse of the transform used in step 330. In some embodiments, the transform used in step 368 is an inverse Fourier transform, although as previously explained other transforms may be used. The inverse transform is performed according to Equation 8:

ψ′ⱼ(r)=T⁻¹[Ψ_{j,new}(u)] Equation 8

In steps 370 and 375 the probe and object function are updated. The updating provides an improved probe Pⱼ₊₁(r) and object guess O_{J+1}(r). The updating may be performed as described in the incorporated reference WO 201/064051, or by any other method. As described in WO 201/064051, the object function may be updated according to Equation 9 and the probe function according to Equation 10:

$${O}_{j + 1} ( r ) = Oj ( r ) + α \frac{{P}_{j}^{*} ( r )}{\vert {P}_{j} ( r ) {\vert}_{max}^{2}} ( {ψ}_{j}^{′} ( r ) - {ψ}_{j} ( r ) ) \qquad Equation 9$$

The parameter α governs the rate of change of the object guess. This value may be adjusted between 0 and 2 as higher values may lead to instability in the updated object guess. According to embodiments of the present invention the probe function is reconstructed in much the same manner as the object function. Aptly the probe function guess is carried out concurrently with the update of the object guess. (It will be appreciated that the probe Function could optionally be updated more often or less often than the object Function).

$${P}_{j + 1} ( r ) = {P}_{j} ( r ) + β \frac{{O}_{j}^{*} ( r )}{\vert {O}_{j} ( r ) {\vert}_{max}^{2}} ( {ψ}_{j}^{′} ( r ) - {ψ}_{j} ( r ) ) \qquad Equation 10$$

The result of this update function generates the running estimate for the probe function. The parameter β governs the rate of change of the probe guess. This value may be adjusted between 0 and 2 as higher values may lead to instability in the updated probe guess.

In step 380 it is determined whether every probe position for the current iteration has been addressed. In other words, it is determined in some embodiments whether j=J. If the current probe position is not the last probe position of the current iteration, then the next probe position is selected. The next probe position may be selected in step 385 by j=j+1. However, if the current probe position is the last probe position for the current iteration, then the method moves to step 390.

In step 390 it is determined whether a check condition is met. In some embodiments, the check condition may be determining whether the current iteration number k is a predetermined value, such as k=100 i.e. determining whether a predetermined number of iterations have been performed. Whilst this check is computationally easy, it takes no account of the accuracy of the image data. Therefore, in some embodiments, the check condition compares a current estimate of the diffraction pattern against that recorded by the detector 40. The comparison may be made considering a sum squared error (SSE) as in Equation 11:

$$SSE = \frac{{( \vert {I}_{fwd} {\vert}^{2} - {I}_{j , e} )}^{2}}{N} \qquad Equation 11$$

Where N is a number of pixels in the array representing the wave function. The method may end when the SSE meets one or more predetermined criteria, such as being below a predetermined value.

If the predetermined criteria is not met, then the method moves to step 395 in preparation for a next iteration (k=k+1) where the probe position is reset i.e. the first probe position is reselected, such as j=1.

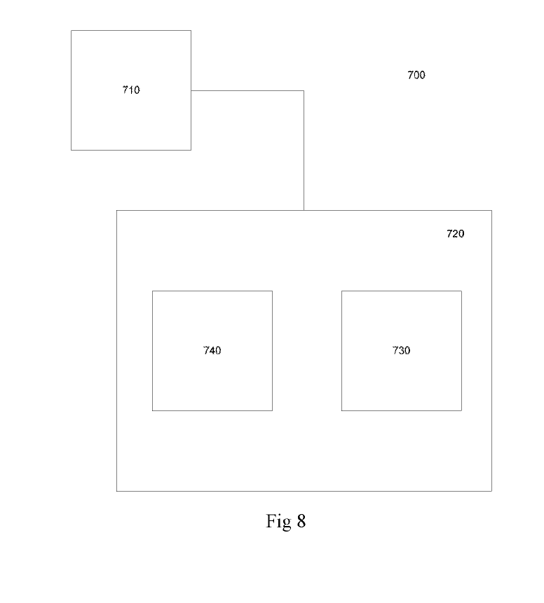

FIG. 8 illustrates an apparatus 700 according to an embodiment of the invention. The apparatus 700 comprises a processing unit 720 which is communicatively coupled, at least periodically, with a detector 710. The processing unit 710 may be communicably coupled to the detector 710 by means of an electrical connection which may be in the form of a communication network, or by means of a data storage medium. The detector 710 corresponds to the detector 40 discussed above. The processing unit 720 comprises a processing means 730 in the form of one or more processing devices which operatively execute computer instructions. The computer instructions may be arranged to cause the processing unit 720 to perform a method according to an embodiment of the invention as described above. The computer instructions may be stored in a computer readable medium such as a memory device 740 accessible to the processing means 730. Data indicative of the set of diffraction patterns as received from the detector 710 may be stored in the memory device 740.

As can be appreciated, embodiments of the present invention provide methods whereby a detector having a plurality of elements can be used to measure an intensity of radiation, wherein the plurality of elements do not correspond directly to an array of elements at which the radiation is estimated.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A computationally implemented method, the method comprising:
determining an array of elements at which a wavefront is to be estimated;
determining a mapping between one or more of a plurality of detector elements of a detector at which incident radiation is to be measured and one or more of the array elements; and
iteratively estimating the wavefront at the one or more of the plurality of detector elements, wherein said iteratively estimating comprises:
determining an estimated wavefront at the array of elements; and
determining an estimated intensity of radiation at the detector based on an intensity of radiation measured at the detector scattered from a target object and the mapping between the array of elements and the one or more of the plurality of detector elements.

2. The method of claim 1, wherein the determining the estimated intensity of radiation at the detector comprises combining the estimated wavefront at the array of elements with the measured intensity of radiation according to the mapping.

3. The method of claim 1, wherein the estimated intensity of radiation at the detector is updated based on the intensity of radiation measured at the detector.

4. The method of claim 1, wherein the mapping between the array of elements and the one or more of the plurality of detector elements is determined at a plane of the detector.

5. The method of claim 2, wherein the estimated intensity of radiation is determined according to:
$${Ψ}_{j , new} ( u ) = {Ψ}_{j} ( u ) . \sqrt{\frac{{I}_{j , e}}{{Σ}_{px} {a}_{px} . \vert {Ψ}_{j} ( px ) {\vert}^{2}}}$$
wherein Ψ_{j,new}(u) is an updated estimated wavefront, Ψⱼ(u) is the estimated wavefront, I_{j,e} is the intensity of radiation measured at the detector, e is the detector element which is mapped to one or more pixels, px, in the estimated wavefront and apx is a weighting factor for each pixel.

6. The method of claim 1, comprising estimating an exit wave from the target object.

7. The method of claim 6, comprising transforming the exit wave to determine the estimate of the wavefront at the array of elements.

8. The method of claim 7, wherein the transforming comprising applying a Fourier transform to the exit wave.

9. The method of claim 6, wherein the exit wave from the target object is based on an object function indicative of one or more properties of the target object and a probe function indicative of one or more properties of the radiation.

10. The method of claim 1, wherein each detector element is associated with a plurality of array elements.

11. The method of claim 1, wherein each array element is associated with a plurality of detector elements.

12. The method of claim 1, wherein the mapping is indicative of a portion of the array elements associated with the one or more detector elements.

13. The method of claim 1, wherein the mapping comprises identification information for each detector element associated with each array element.

14. The method of claim 1, wherein the mapping comprises, for each array element, a weighting value.

15. The method of claim 14, wherein the weighting value is indicative of a relative contribution of each array element to the detector element.

16. The method of claim 14, wherein the weighting value is between first and second predetermined values.

17-19. (canceled)

20. Computer executable cored stored on a computer readable medium which, when executed by a computer is arranged to perform a method according to claim 1.

21. An apparatus for determining a position of an object with respect to incident radiation, comprising:
a detector for measuring an intensity of a radiation incident thereon scattered from an object, the detector comprising a plurality of detector elements;
a processing device arranged to receive intensity data from the detector and to iteratively estimate a wavefront at the one or more of the plurality of detector elements, wherein said iteratively estimating comprises:
determining an estimated wavefront at the array of elements; and
determining an estimated intensity of radiation at the detector based on an intensity of radiation measured at the detector scattered from a target object and the mapping between the array of elements and the one or more of the plurality of detector elements.

22. The method of claim 16, wherein the second predetermined value indicates a full contribution, and the first predetermined value indicates less contribution.

23. The method of claim 1, wherein the wavefront is estimated by one of a ptychographic method and an iterative phase retrieval method.

24. The method of claim 23, wherein the wavefront is estimated based on a probe function indicative of one or more characteristics of radiation incident on an object or a post-object aperture, and an object function indicative of one or more characteristics of the object.
